(19) United States
(12) Patent Application Publication
(10) Pub. No.: US 2013/0249882 A1
(43) Pub. Date: Sep. 26, 2013

(54) Liquid Crystal Display Device and Driving Method

(71) Applicants: Chia chiang Lin, Shenzhen (CN); Hung-lung Hou, Shenzhen (CN); Chengming He, Shenzhen (CN)

(72) Inventors: Chia chiang Lin, Shenzhen (CN); Hung-lung Hou, Shenzhen (CN); Chengming He, Shenzhen (CN)

(73) Assignee: SHENZHEN CHINA STAR OPTOELECTRONICS TECHNOLOGY, CO., LTD., Shenzhen (CN)

(21) Appl. No.: 13/519,358

(22) PCT Filed: Mar. 30, 2012
(86) PCT No.: PCT/CN12/73289

§ 371 Date: Jun. 27, 2012

(30) Foreign Application Priority Data
Mar. 26, 2012 (CN) 201210082946.8

(51) Int. Cl. G09G 3/36; G06F 3/038

(52) U.S. Cl. 345/212; 345/92

(57) ABSTRACT

A liquid crystal display device includes a first voltage source providing a first voltage; a second voltage source providing a second voltage greater than the first voltage; and a switching unit arranged at a connection between a gate terminal of a first TFT and a scan line. The switching unit has a control terminal electrically connected to the scan line, an input terminal electrically connected to the first voltage source, and an output terminal electrically connected to the second voltage source and a common electrode of a storage capacitor of a pixel unit. When the switching unit receives a scan signal, the first voltage source supplies the first voltage to the common electrode of the storage capacitor of the pixel unit. When no scan signal is received, the second voltage source supplies the second voltage to the common electrode of the storage capacitor of the pixel unit.

### BACKGROUND OF THE INVENTION

1. Field of the Invention

The present invention relates to the field of displaying techniques, and in particular to a liquid crystal display device and a driving method thereof.

2. The Related Arts

A liquid crystal display device often comprises a first substrate, a second substrate, and a liquid crystal layer arranged between the first substrate and the second substrate. The liquid crystal display device comprises a plurality of pixel units, each of which comprises a pixel electrode made of indium tin oxide and formed on the first substrate and a common electrode formed on the second substrate.

As shown in FIG. 1, a single pixel unit is taken as an example for illustration purposes. A known driving circuit for liquid crystal display device comprises: a scan line 110, a data line 120, a first TFT (Thin Film Transistor) 130, a liquid crystal capacitor 141, and a storage capacitor 142. The liquid crystal capacitor 141 is constituted by a pixel electrode 1411 formed on the first substrate and a common electrode 1413 formed on the second substrate. The storage capacitor 142 is constituted by the pixel electrode 1411 and a common electrode 1423 formed on the first substrate. The first TFT 130 has a gate terminal g electrically connected to the scan line 110, a source terminal electrically connected to the data line 120, and a drain terminal d electrically connected to the pixel electrode 1411 of the liquid crystal capacitor 141 and the storage capacitor 142.

In operation, a scan signal is applied through the scan line 110 to the gate terminal g of the first TFT 130 to conduct the first TFT 130 on. A data signal is applied through the data line 120 to the source terminal s of the first TFT 130. When the scan signal sets the first TFT 130 in a conduction condition, the data signal is applied through the drain terminal d of the first TFT 130 to the pixel electrode 1411 of the liquid crystal capacitor 141. When the voltage applied across the liquid crystal capacitor 141 varies, the orientation of liquid crystal molecules of the liquid crystal layer is changed to thereby change the transmission rate of light transmitting through the pixel unit and thus controlling displayed brightness of the pixel unit. FIG. 2 is a plot showing the scan signal and the waveform of voltage detected on the pixel electrode of the circuit shown in FIG. 1. Also referring to FIG. 2, due to the existence of parasitic capacitor 150, at the very moment when the first TFT 130 is turned off (namely the time when the scan signal 210 is at the descending edge), the parasitic capacitor 150 conducts the scan signal 210 to the pixel electrode 1411, thereby lowering the level of voltage 220 applied to the pixel electrode 1411. Such an amount of voltage reduced in this way is often referred to as “feed-through voltage”.

Since the parasitic capacitors 150 of a specific scan line 110 are gradually increased from two opposite sides of a display panel toward a center, this leads a gradually reduction of the feed-through voltage applied through the parasitic capacitor 150, whereby voltage difference between the pixel electrode 1411 and the common electrode 1413 that is formed on the second substrate is gradually increased. Consequently, the level of the feed-through voltage at different locations is different, wherein the feed-through voltage is relatively large at locations close to edges of the display panel and the feed-through voltage at the central area of the liquid crystal display panel is relatively small. As a consequence, for a low grey scale image, the left and right side edges of the liquid crystal display panel show relatively great brightness, leading to a defect of non-uniformity of brightness and affecting the quality of displaying.

### SUMMARY OF THE INVENTION

The primary technical issue to be addressed by the present invention is to provide a liquid crystal display device and a driving method thereof, which may correct difference of feed-through voltages of the same scan line that is caused by parasitic resistor and parasitic capacitor in order to improve uniformity of brightness of the liquid crystal display device.

To address the above technical issue, the present invention adopts a technical solution by providing a liquid crystal display device. The liquid crystal display device comprises a plurality of pixel units arranged in an array and the pixel unit comprises a first substrate and a second substrate that are arranged opposite to each other and a liquid crystal layer interposed between the first and second substrates; wherein the first substrate comprises a data line and a scan line intersecting the data line, a pixel electrode formed in an area delimited by two adjacent scan lines and two adjacent data lines, and a first thin film transistor arranged at the intersection of the data line and the scan line, the first thin film transistor having a gate terminal connected to the scan line, a source terminal connected to the data line, and a drain terminal connected to the pixel electrode; wherein the liquid crystal display device further comprises: a first voltage source, which functions to provide a first voltage; a second voltage source, which functions to provide a second voltage; and a switching unit, which is arranged at the connection between the gate terminal of the first thin film transistor and the scan line, the switching unit having a control terminal electrically connected to the scan line, an input terminal electrically connected to the first voltage source, and an output terminal electrically connected to the second voltage source and a common electrode of a storage capacitor of the pixel unit; wherein the switching unit comprises at least one thin film transistor and the switching unit has a gate terminal electrically connected to the scan line, a source terminal electrically connected to the first voltage source, and a drain terminal electrically connected to a common terminal of the second voltage source and the common electrode of the storage capacitor of the pixel unit, the storage capacitor being formed of the pixel electrode and the common electrode of the storage capacitor, wherein the pixel electrode and the common electrode of the storage capacitor are formed on the first substrate; whereby when the switching unit receives a scan signal, the first voltage source supplies the first voltage to the common electrode of the storage capacitor of the pixel unit; and when the switching unit receives no scan signal, the second voltage source supplies the second voltage to the common electrode of the storage capacitor of the pixel unit so as to reduce difference of feed-through voltage between a plurality of pixel units of the scan line; and wherein the first voltage is less than the second voltage.

Wherein, the liquid crystal capacitor is constituted by the pixel electrode, the common electrode formed on the second substrate, and the liquid crystal layer, the common electrode formed on the second substrate being electrically connected to the second voltage source.

Wherein, the first voltage has a voltage value of 6.8V and the second voltage has a voltage value of 7.5V.

To address the above technical issue, the present invention adopts another technical solution by providing a liquid crystal display device. The liquid crystal display device comprises a plurality of pixel units arranged in an array and the pixel unit comprises a first substrate and a second substrate that are arranged opposite to each other and a liquid crystal layer interposed between the first and second substrates; wherein the first substrate comprises a data line and a scan line intersecting the data line, a pixel electrode formed in an area delimited by two adjacent scan lines and two adjacent data lines, and a first thin film transistor arranged at the intersection of the data line and the scan line, the first thin film transistor having a gate terminal connected to the scan line, a source terminal connected to the data line, and a drain terminal connected to the pixel electrode; wherein the liquid crystal display device further comprises: a first voltage source, which functions to provide a first voltage; a second voltage source, which functions to provide a second voltage; and a switching unit, which is arranged at the connection between the gate terminal of the first thin film transistor and the scan line, the switching unit having a control terminal electrically connected to the scan line, an input terminal electrically connected to the first voltage source, and an output terminal electrically connected to the second voltage source and a common electrode of a storage capacitor of the pixel unit; whereby when the switching unit receives a scan signal, the first voltage source supplies the first voltage to the common electrode of the storage capacitor of the pixel unit; and when the switching unit receives no scan signal, the second voltage source supplies the second voltage to the common electrode of the storage capacitor of the pixel unit so as to reduce difference of feed-through voltage between a plurality of pixel units of the scan line; and wherein the first voltage is less than the second voltage.

Wherein, the switching unit comprises at least one thin film transistor and the switching unit has a gate terminal electrically connected to the scan line, a source terminal electrically connected to the first voltage source, and a drain terminal electrically connected to a common terminal of the second voltage source and the common electrode of the storage capacitor of the pixel unit.

Wherein, the switching unit comprises at least one bipolar transistor and the switching unit has a base terminal electrically connected to the scan line, a collector terminal electrically connected to the first voltage source, and an emitter terminal electrically connected to a common terminal of the second voltage source and the common electrode of the storage capacitor of the pixel unit.

Wherein, the switching unit comprises a composite bipolar transistor comprising a plurality of thin film transistors and bipolar transistors, the control terminal of the switching unit being electrically connected to the scan line, the input terminal being electrically connected to the first voltage source, the output terminal being electrically connected to the common terminal of the second voltage source and the common electrode of the storage capacitor of the pixel unit.

Wherein, the storage capacitor is constituted by the pixel electrode and the common electrode of the storage capacitor, wherein the pixel electrode and the common electrode of the storage capacitor are both formed on the first substrate.

Wherein, the liquid crystal capacitor is constituted by the pixel electrode, the common electrode formed on the second substrate, and the liquid crystal layer, the common electrode formed on the second substrate being electrically connected to the second voltage source.

Wherein, the first voltage has a voltage value of 6.8V and the second voltage has a voltage value of 7.5V.

To address the above technical issue, the present invention adopts a further technical solution by providing a method for driving liquid crystal display device. The liquid crystal display device comprises a plurality of pixel units arranged in an array. The driving method comprises the following steps: providing a first voltage source, which functions to provide a first voltage; providing a second voltage source, which functions to provide a second voltage; providing a first switching unit, which functions to control the first voltage source and the second voltage source to supply the first voltage or the second voltage to the common electrode of the storage capacitor of the pixel unit; wherein when the switching unit receives a scan signal, the first voltage source supplies the first voltage to a common electrode of a storage capacitor of the pixel unit; and when the switching unit receives no scan signal, the second voltage source supplies the second voltage to the common electrode of the storage capacitor of the pixel unit so as to reduce difference of feed-through voltage between a plurality of pixel units of a scan line; wherein the first voltage is less than the second voltage.

Wherein, the method further comprises: providing a second switching unit, which functions to control the data line of the liquid crystal display device to supply data voltage to the pixel unit; wherein an identical scan signal is supplied to the first switching unit and the second switching unit so as to have both the first switching unit and the second switching unit to turn on or off simultaneously.

Wherein, a common voltage is applied to the common electrodes of the liquid crystal capacitors of a plurality of pixel units of a scan line, the common voltage having a voltage value that is equal to the first voltage.

Wherein, the first switching unit is a thin film transistor or a bipolar transistor and the second switching unit is a thin film transistor.

Wherein, the first voltage has a voltage value of 6.8V and the second voltage has a voltage value of 7.5V.

The efficacy of the present invention is that to be distinguished from the known techniques, according to the present invention, when a scan signal is received through the switching unit, the first voltage source supplies a first voltage to the pixel unit, and when the switching unit receives no scan signal, the second voltage source supplies a second voltage to the pixel unit, and the first voltage is less than the second voltage, whereby correction can be effected on the difference of feed-through voltage that is caused by different parasitic resistors and parasitic capacitors of the same scan line of the liquid crystal display device, thus the brightness uniformity of the liquid crystal display device can be improved.

### BRIEF DESCRIPTION OF THE DRAWINGS

FIG. 1 is a circuit diagram showing a driving circuit of a conventional liquid crystal display device;

FIG. 2 is a plot showing a scan signal and waveform of voltage detected on a pixel electrode of the circuit shown in FIG. 1;

FIG. 3 is a schematic view showing the structure of a liquid crystal display device according to the present invention;

FIG. 4 is a diagram showing a driving circuit of the liquid crystal display device according to the present invention;

FIG. 5 is a circuit diagram of an embodiment of the driving circuit shown in FIG. 4;

FIG. 6 is a flow chart showing a driving method of liquid crystal display device according to the present invention; and

FIG. 7 is a plot showing comparison of signal waveforms for two pixel units of the same scan line and respectively located at an edge and a center of the liquid crystal display device according to the p″resent invention.

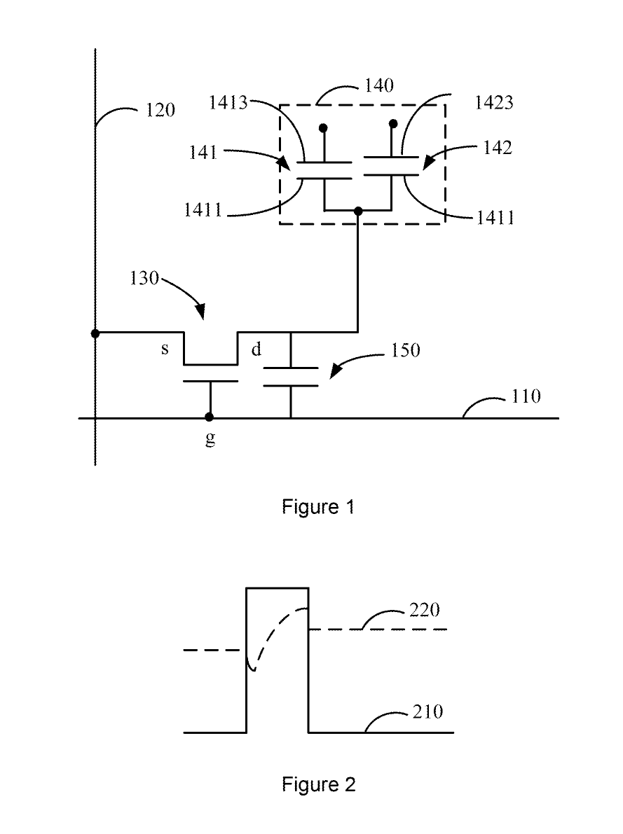

### DETAILED DESCRIPTION OF THE PREFERRED EMBODIMENTS

A detailed description will be given hereinafter with reference to the accompanying drawings and embodiments.

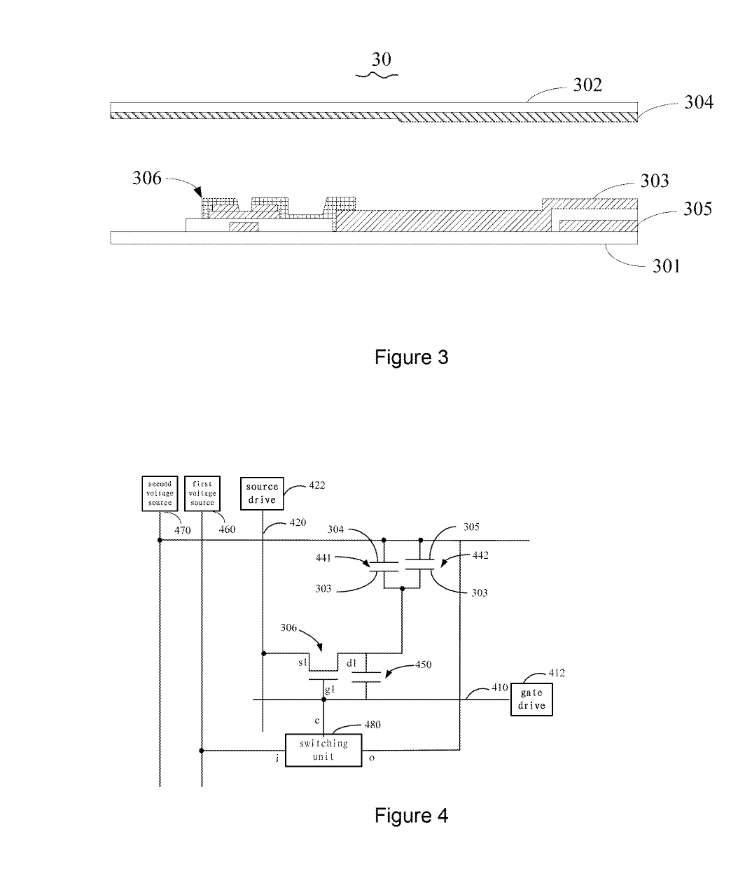

The present invention aims to provide a liquid crystal display device, which comprises a plurality of pixel units arranged in an array. As shown in FIG. 3, each pixel unit 30 comprises a first substrate 301 and a second substrate 302 that are arranged opposite to each other and a liquid crystal layer (not shown) interposed between the first substrate 301 and the second substrate 302. In the embodiment, the first substrate 301 is a TFT (Thin Film Transistor) substrate and the second substrate 302 is a CF (Color Filter) substrate.

FIG. 4 is diagram showing a driving circuit of the liquid crystal display device according to the present invention. Referring to both FIGS. 3 and 4, taking a single pixel unit as an example, in the instant embodiment, the driving circuit of the liquid crystal display device comprises: a scan line 410, a data line 420, a first TFT 306, a liquid crystal capacitor 441, a storage capacitor 442, a parasitic capacitor 450, a first voltage source 460, a second voltage source 470, and a switching unit 480.

The scan line 410, the data line 420, and the first TFT 306 are formed on the first substrate 301 in an insulated intersection manner. The scan line 410 is connected to a gate drive 412 for transmitting a scan signal provided by the gate drive 412. The data line 420 is connected to the source drive 422 for transmitting a data signal provided by the source drive 422.

The pixel electrode 303 is formed on the first substrate 301 in an area delimited by two adjacent scan lines 410 and two adjacent data lines 420.

The liquid crystal capacitor 441 is constituted by the pixel electrode 303 and a common electrode 304 formed on the second substrate 302 and the liquid crystal layer. The storage capacitor 442 is constituted by the pixel electrode 303 and a common electrode 305 that is also formed on the first substrate 301.

The first TFT 306 is arranged at the intersection between the scan line 410 and the data line 420. The first TFT 306 has a gate terminal g1 that is electrically connected to the scan line 410, a source terminal s1 that is electrically connected to the data line 420, and a drain terminal d1 that is electrically connected to the pixel electrode 303.

The first voltage source 460 functions to provide a first voltage. In the instant embodiment, the first voltage has a voltage value of 6.8V.

The second voltage source 470 functions to provide a second voltage. In the instant embodiment, the second voltage has a voltage value of 7.5V. It is noted that in the present invention, the values of the first voltage and the second voltage are not limited to above example values and it is only required that the relationship that the voltage value of the first voltage is smaller than that of the second voltage is satisfied.

The common electrode 304 of the liquid crystal capacitor 441 and the common electrode 305 of the storage capacitor 442 are both electrically connected to the second voltage source 470.

The parasitic capacitor 450 has two terminals that are respectively and electrically connected to the gate terminal g1 and the drain terminal d1.

The switching unit 480 is arranged at the connection between the gate terminal g1 of the first TFT 306 and the scan line 410 to effect selective connection with the first voltage source 460 or the second voltage source 470. The switching unit 480 has a control terminal c that is electrically connected to the scan line 410, an input terminal i that is electrically connected to the first voltage source 460, and an output terminal o that is electrically connected to the second voltage source 470, the common electrode 304 of the liquid crystal capacitor 441, and the common electrode 305 of the storage capacitor 442.

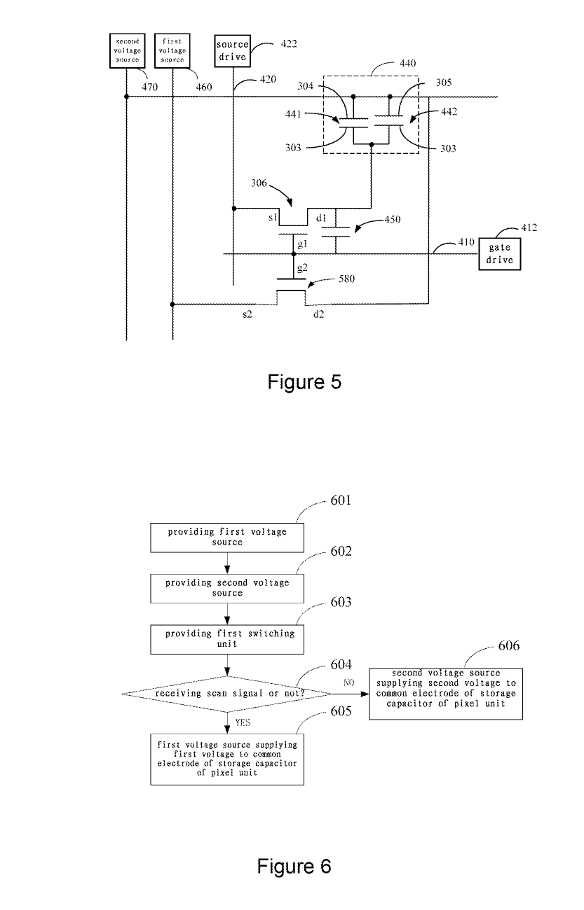

Referring to FIG. 5, FIG. 5 is a circuit diagram of an embodiment of the driving circuit of the liquid crystal display device according to the present invention.

In the instant embodiment, a TFT 580 is provided to serve as the switching unit, comprising a gate terminal g2 that is electrically connected to the scan line 410, a source terminal s2 that is electrically connected to the first voltage source 460, and a drain terminal d2 that is electrically connected to the second voltage source 470, the common electrode 304 of the liquid crystal capacitor 441, and the common electrode 305 of the storage capacitor 442.

It is understood that in the above discussed embodiment, the TFT 580 can be replaced by a bipolar transistor. In this regard, the bipolar transistor has a base terminal that is electrically connected to the scan line 410, a collector terminal that is electrically connected to the first voltage source 460, and an emitter terminal that is electrically connected to a common terminal of the second voltage source 470 and the common electrode 305 of the storage capacitor 442 of the pixel unit.

Similarly, in the above-discussed embodiment, the TFT 580 can be constituted by a composite bipolar transistor that comprises multiple TFTs or multiple bipolar transistors, or a composite bipolar transistor that comprises multiple TFTs and bipolar transistor, in order to form other embodiments. The present invention applies no specific limitation thereto.

It is noted that in the present invention, the common electrode 304 of the second substrate 302 and the common electrode 305 of the first substrate 301 may be arranged to be directly connected to each other and are instead provided, respectively with electrical voltages from two different voltage sources with the voltages of the two voltage sources being severely set equal to each other.

According to another aspect of the present invention, the present invention also provides a method for driving a liquid crystal display device. As shown in FIG. 6, the driving method according to the present invention comprises the following steps:

Step 601: providing a first voltage source.

The first voltage source functions to provide a first voltage. In the instant embodiment, the first voltage has a voltage value of 6.8V.

Step 602: providing a second voltage source.

The second voltage source functions to provide a second voltage. In the instant embodiment, the second voltage has a voltage value of 7.5V. The voltage value of the second voltage is greater than that of the first voltage.

Step 603: providing a first switching unit.

The first switching unit can be a TFT or a bipolar transistor, which functions to control the first voltage source and the second voltage source to supply the first voltage or the second voltage to the common electrode of the storage capacitor of the pixel unit.

Step 604: determining if the first switching unit receive a scan signal. If the answer is positive, then executing Step 605; otherwise if the answer is negative, then executing Step 606.

Step 605: the first voltage source supplying a first voltage to the common electrode of the storage capacitor of the pixel unit.

Step 606: the second voltage source supplying a second voltage to the common electrode of the storage capacitor of the pixel unit.

In the following, a driving circuit of the display device according to the present invention that realizes the above described driving method and an actual operation of the driving method will be described in details.

The actual operation of the driving circuit and the driving method according to the present invention are as follows:

Referring again to FIG. 4, since the gate terminal of the first TFT 306 and the control terminal c of the switching unit 480 are connected to the same node of the scan line 410, they can receive the same scan signal to be simultaneously conducted on or off.

Specifically, when the scan line 410 is supplied with the scan signal, the first TFT 306 and the switching unit 480 are conducted on and the data signal applies a load through the data line 420 and the first TFT 306 to the pixel electrode 303. Also, since the switching unit 480 is conducted on, the first voltage source 460 supplies the first voltage through the switching unit 480 to the common electrode 305 of the storage capacitor 442 of the pixel unit to induce a voltage difference between the pixel electrode 303 and the common electrode 304 that is formed on the second substrate, causing re-orientation of the liquid crystal layer.

It is noted that in the instant embodiment, the liquid crystal display device adopts column scanning, whereby each time a scan is made, a common voltage is applied to the common electrodes 304 of the liquid crystal capacitors 441 of a number of pixel units in connection with the same scan line 410 and the common voltage is set at a value that is equal to the first voltage provided by the first voltage source 460.

When no scan signal is received, the first TFT 306 is set off and the switching unit 480 is also switched off. Under this condition, the second voltage source 470 directly supplies the second voltage to the common electrode 305 of the storage capacitor 442 of the pixel unit. Since the first voltage is smaller than the second voltage, the second voltage that is larger and is supplied at the time when the first TFT 306 is off raises the voltage level of the pixel electrode 303, effecting a correction of feed-through voltage.

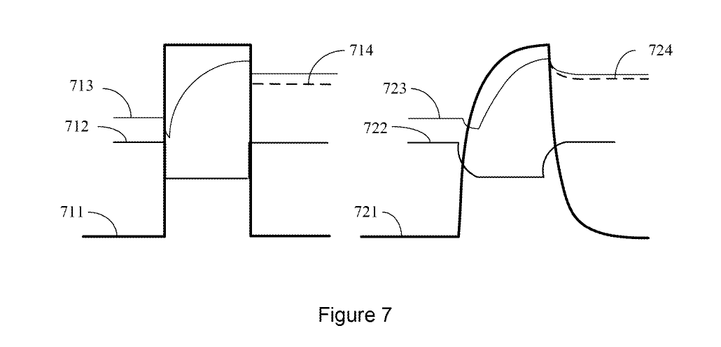

Referring to FIG. 7, FIG. 7 is a plot showing comparison of signal waveforms for two pixel units of the same scan line and respectively located at an edge and a center of the liquid crystal display device according to the present invention.

Curve 711 is the voltage signal of the control terminal of the switching unit for the edge-located pixel unit and curve 721 is the voltage signal of the control terminal of the switching unit for the center-located pixel unit. In the instant embodiment, when curves 711, 712 are of high levels, the first TFT is conducted on.

Curves 712, 722 respectively indicate voltage signals of the common electrodes of the storage capacitors for the pixel units.

Curves 713, 723 respectively indicate voltage signals of the pixel electrodes of the pixel units, which are the voltage signals of the pixel electrodes after the correction of the feed-through voltages according to the present invention.

Curves 714, 724 respectively indicate voltage signals of the pixel electrodes of the pixel units under a condition where the second voltage source and the switching unit are not provided, namely the voltage signals of the pixel electrodes with no correction of feed-through voltage being made.

It can be seen from FIG. 7 that when curves 711, 712 are at low levels and the first TFT is turned off, the voltage differences between the pixel electrodes and the common electrodes of the two pixel units that are respectively located at an edge and a center according to the present invention show a difference therebetween that is smaller than the case where the second voltage source and the switching unit are not provided. Further, referring to FIG. 4, according to the present invention, when the parasitic capacitor 450 is relatively small (such as for the edge-located pixel unit), the correction made on the feed-through voltage is great; on the other hand, when the parasitic capacitor 450 is relatively great (such as for the center-located pixel unit), the correction made on the feed-through voltage is small. In this way, the difference of feed-through voltage caused by different parasitic resistors and parasitic capacitors of pixel units of the same scan line but at different locations can be corrected, making the difference in feed-through voltages of different pixel units significantly reduced thereby effectively alleviating the problem of relatively great brightness found at the left and right sides of a display screen for low grey scale condition.

Experiments show that before the correction, the voltage of the pixel electrode of an edge-located pixel unit is −1.44108V and that of the pixel electrode of a center-located pixel unit is −0.99628V; and after the correction, the voltage of the pixel electrode of the edge-located pixel unit is −1.01600V and that of the pixel electrode of a center-located pixel unit is −0.99628V, the voltage difference of the two being less than 0.02V, making it possible to achieve excellent result.

To be distinguished from the known techniques, according to the present invention, when a scan signal is received through the switching unit, the first voltage source supplies a first voltage to the pixel unit, and when the switching unit receives no scan signal, the second voltage source supplies a second voltage to the pixel unit, and the first voltage is less than the second voltage, whereby correction can be effected on the difference of feed-through voltage that is caused by different parasitic resistors and parasitic capacitors of the same scan line of the liquid crystal display device, thus the brightness uniformity of the liquid crystal display device can be improved.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A liquid crystal display device, comprising a plurality of pixel units arranged in an array, the pixel unit comprising a first substrate and a second substrate that are arranged opposite to each other and a liquid crystal layer interposed between the first and second substrates;
wherein the first substrate comprises a data line and a scan line intersecting the data line, a pixel electrode formed in an area delimited by two adjacent scan lines and two adjacent data lines, and a first thin film transistor arranged at the intersection of the data line and the scan line, the first thin film transistor having a gate terminal connected to the scan line, a source terminal connected to the data line, and a drain terminal connected to the pixel electrode;
wherein the liquid crystal display device further comprises:
a first voltage source, which functions to provide a first voltage;
a second voltage source, which functions to provide a second voltage; and
a switching unit, which is arranged at the connection between the gate terminal of the first thin film transistor and the scan line, the switching unit having a control terminal electrically connected to the scan line, an input terminal electrically connected to the first voltage source, and an output terminal electrically connected to the second voltage source and a common electrode of a storage capacitor of the pixel unit; wherein the switching unit comprises at least one thin film transistor and the switching unit has a gate terminal electrically connected to the scan line, a source terminal electrically connected to the first voltage source, and a drain terminal electrically connected to a common terminal of the second voltage source and the common electrode of the storage capacitor of the pixel unit, the storage capacitor being formed of the pixel electrode and the common electrode of the storage capacitor, wherein the pixel electrode and the common electrode of the storage capacitor are formed on the first substrate;
whereby when the switching unit receives a scan signal, the first voltage source supplies the first voltage to the common electrode of the storage capacitor of the pixel unit; and when the switching unit receives no scan signal, the second voltage source supplies the second voltage to the common electrode of the storage capacitor of the pixel unit so as to reduce difference of feed-through voltage between a plurality of pixel units of the scan line; and
wherein the first voltage is less than the second voltage.

2. The device as claimed in claim 1, wherein the liquid crystal capacitor is constituted by the pixel electrode, the common electrode formed on the second substrate, and the liquid crystal layer, the common electrode formed on the second substrate being electrically connected to the second voltage source.

3. The device as claimed in claim 1, wherein the first voltage has a voltage value of 6.8V and the second voltage has a voltage value of 7.5V.

4. A liquid crystal display device, comprising a plurality of pixel units arranged in an array, the pixel unit comprising a first substrate and a second substrate that are arranged opposite to each other and a liquid crystal layer interposed between the first and second substrates;
wherein the first substrate comprises a data line and a scan line intersecting the data line, a pixel electrode formed in an area delimited by two adjacent scan lines and two adjacent data lines, and a first thin film transistor arranged at the intersection of the data line and the scan line, the first thin film transistor having a gate terminal connected to the scan line, a source terminal connected to the data line, and a drain terminal connected to the pixel electrode;
wherein the liquid crystal display device further comprises:
a first voltage source, which functions to provide a first voltage;
a second voltage source, which functions to provide a second voltage; and
a switching unit, which is arranged at the connection between the gate terminal of the first thin film transistor and the scan line, the switching unit having a control terminal electrically connected to the scan line, an input terminal electrically connected to the first voltage source, and an output terminal electrically connected to the second voltage source and a common electrode of a storage capacitor of the pixel unit;
whereby when the switching unit receives a scan signal, the first voltage source supplies the first voltage to the common electrode of the storage capacitor of the pixel unit; and when the switching unit receives no scan signal, the second voltage source supplies the second voltage to the common electrode of the storage capacitor of the pixel unit so as to reduce difference of feed-through voltage between a plurality of pixel units of the scan line; and
wherein the first voltage is less than the second voltage.

5. The device as claimed in claim 4, wherein the switching unit comprises at least one thin film transistor and the switching unit has a gate terminal electrically connected to the scan line, a source terminal electrically connected to the first voltage source, and a drain terminal electrically connected to a common terminal of the second voltage source and the common electrode of the storage capacitor of the pixel unit.

6. The device as claimed in claim 4, wherein the switching unit comprises at least one bipolar transistor and the switching unit has a base terminal electrically connected to the scan line, a collector terminal electrically connected to the first voltage source, and an emitter terminal electrically connected to a common terminal of the second voltage source and the common electrode of the storage capacitor of the pixel unit.

7. The device as claimed in claim 4, wherein the switching unit comprises a composite bipolar transistor comprising a plurality of thin film transistors and bipolar transistors, the control terminal of the switching unit being electrically connected to the scan line, the input terminal being electrically connected to the first voltage source, the output terminal being electrically connected to the common terminal of the second voltage source and the common electrode of the storage capacitor of the pixel unit.

8. The device as claimed in claim 4, wherein the storage capacitor is constituted by the pixel electrode and the common electrode of the storage capacitor, wherein the pixel electrode and the common electrode of the storage capacitor are both formed on the first substrate.

9. The device as claimed in claim 4, wherein the liquid crystal capacitor is constituted by the pixel electrode, the common electrode formed on the second substrate, and the liquid crystal layer, the common electrode formed on the second substrate being electrically connected to the second voltage source.

10. The device as claimed in claim 4, wherein the first voltage has a voltage value of 6.8V and the second voltage has a voltage value of 7.5V.

11. A method for driving liquid crystal display device, wherein the liquid crystal display device comprises a plurality of pixel units arranged in an array, the method comprising the following steps:
providing a first voltage source, which functions to provide a first voltage;
providing a second voltage source, which functions to provide a second voltage;
providing a first switching unit, which functions to control the first voltage source and the second voltage source to supply the first voltage or the second voltage to the common electrode of the storage capacitor of the pixel unit;
wherein when the switching unit receives a scan signal, the first voltage source supplies the first voltage to a common electrode of a storage capacitor of the pixel unit;
when the switching unit receives no scan signal, the second voltage source supplies the second voltage to the common electrode of the storage capacitor of the pixel unit so as to reduce difference of feed-through voltage between a plurality of pixel units of a scan line;
wherein the first voltage is less than the second voltage.

12. The method as claimed in claim 11, wherein the method further comprises:
providing a second switching unit, which functions to control the data line of the liquid crystal display device to supply data voltage to the pixel unit;
wherein an identical scan signal is supplied to the first switching unit and the second switching unit so as to have both the first switching unit and the second switching unit to turn on or off simultaneously.

13. The method as claimed in claim 12, wherein
a common voltage is applied to the common electrodes of the liquid crystal capacitors of a plurality of pixel units of a scan line, the common voltage having a voltage value that is equal to the first voltage.

14. The method as claimed in claim 11, wherein the first switching unit is a thin film transistor or a bipolar transistor and the second switching unit is a thin film transistor.

15. The method as claimed in claim 11, wherein the first voltage has a voltage value of 6.8V and the second voltage has a voltage value of 7.5V.
